(19) United States
(12) Patent Application Publication
(10) Pub. No.: US 2014/0320932 A1
(43) Pub. Date: Oct. 30, 2014

(54) System and Method for Extracting a Plurality of Images from a Single Scan

(71) Applicant: MAKING EVERLASTING MEMORIES, L.L.C., Cincinnati, OH (US)

(72) Inventors: Michael M. Piehler, Loveland, OH (US); Shawna M. Becknell, Cincinnati, OH (US); Benjamin M. Evans, Norwood, OH (US); Jeffrey J. Johnson, West Chester, OH (US); Steven C. Sefton, West Chester, OH (US); G. Scott Mindrum, Cincinnati, OH (US)

(73) Assignee: MAKING EVERLASTING MEMORIES, L.L.C., Cincinnati, OH (US)

(21) Appl. No.: 14/167,305

(22) Filed: Jan. 29, 2014

Related U.S. Application Data
(63) Continuation of application No. 12/468,931, filed on May 20, 2009, now abandoned.

(51) Int. Cl. H04N 1/00; H04N 1/203

(52) U.S. Cl. CPC H04N 1/0044; H04N 1/2038; H04N 1/00312; H04N 2201/0039; H04N 2201/0075; H04N 2201/043
USPC 358/450

(57) ABSTRACT

A user interface is presented to a remote user via a network, such as through a computer. A preview command is received from the user. A scanning process (e.g., scanning multiple photographs simultaneously) is initiated at a scanner coupled with the user's computer, in response to receiving the preview command. The act of initiating is performed from a location remote from the user. A single scanned image is obtained through the scanner. A plurality of crop selections are received from the user, all of which are made within the single scanned image. Several regions within multiple scanned photographs may be selected for cropping. A plurality of image files are created based on the crop selections. The plurality of image files may be created in response to the user clicking just once on a button presented by the user interface.

### PRIORITY

This application is a continuation of U.S. Non-Provisional patent application Ser. No. 12/468,931, filed May 20, 2009, entitled “System and Method for Extracting a Plurality of Images from a Single Scan,” the disclosure of which is incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Some embodiments of the present invention relate to systems and methods for extracting a plurality of images from a single scan. For instance, a user may place several hard copy photographs on a scanner bed and scan all of the photographs simultaneously, resulting in a single image file. The user may then make several image cropping selections within and among the scanned photographs in the image file. The user's image cropping selections may then be converted into separate images being extracted as separate image files from the single image file, and those separate image files may be simultaneously uploaded to a server, with the single click of a button. Conventional scanning, image processing, and uploading systems and methods are not believed to demonstrate such capabilities. While a variety of systems and methods have been made and used for converting hard copy photographs into digital images, it is believed that no one prior to the inventors has made or used the invention described in the appended claims.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a schematic view of an exemplary image processing system;

FIG. 2 depicts a flow chart showing steps of an exemplary image processing method, from a user's perspective;

FIG. 3 depicts a flow chart showing steps of an exemplary image processing method, from a processor's perspective

FIG. 4 depicts an exemplary graphical user interface during performance of part of the image processing methods of FIGS. 2-3;

FIG. 5 depicts an example of the graphical user interface of FIG. 4 during performance of another part of the image processing methods of FIGS. 2-3;

FIG. 6 depicts an example of the graphical user interface of FIG. 4 upon completion of the image processing methods of FIGS. 2-3.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

Exemplary System Overview

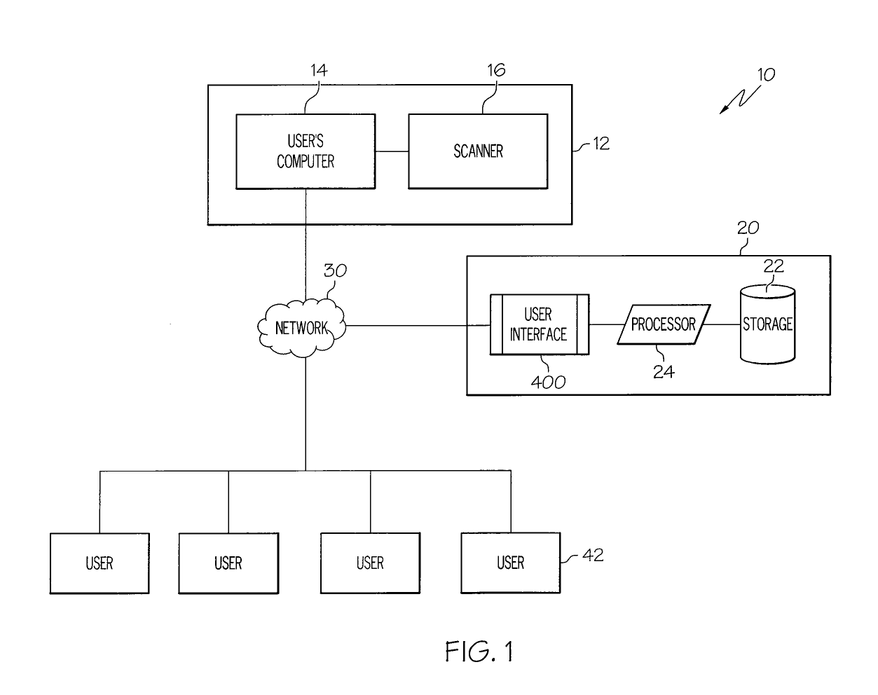

As shown in FIG. 1, an exemplary image processing system (10) includes a user's system (12) and a processor's system (20), which are configured to communicate with one another via a network (30). In some versions, network (30) includes the internet. Alternatively, any other network may be used, including but not limited to public networks or private networks, combinations thereof, etc. In the present example, user's system (12) is used to capture photo images and transmit the images to processor's system (20). In some versions, the photo images are processed, at least in part, by user's system (12) (e.g., using ActiveX controls operating through a web browser on user's system (12), etc.). In addition or in the alternative, processor's system (20) may be used to process the photo images. It will be appreciated, however, that image processing system (10) may include a variety of other components, and that any desired tasks may be performed using any desired components (including combinations of components) of image processing system (10). Furthermore, while examples described herein relate to processing of photographs (e.g., hard copies of photographs that have been scanned and converted into digital image files), image processing system (10) may be used to process any other type(s) of media, including but not limited to digital photographs (e.g., photographs captured by a digital camera), non-photo documents, audio, video, etc., as well as combinations of media types.

User's system (12) in the present example includes a computer (14) and a scanner (16), which is coupled with computer (14). Computer (14) comprises a conventional computer that is capable of connecting to a network (30) (e.g., via one or more wires, wirelessly, etc.). Scanner (16) comprises a conventional scanner that is operable to scan one or more hard copy photographs, film negatives, hard copy slides, documents, etc. By way of example only, scanner (16) may comprise a flatbed scanner. Alternatively, any other type of scanner (16) may be used. Furthermore, any other type(s) of device(s) may be used in addition to or in lieu of scanner (16). For instance, a user may use a digital camera, such as a digital camera with a macro lens or macro feature, to capture a single digital image of several photographs laid out in front of the camera, and then transmit that captured digital image of the photographs to computer (14) for processing as described herein. Still other suitable methods and devices for converting hard copy photographs into one or more digital files will be apparent to those of ordinary skill in the art in view of the teachings herein.

It should also be understood that some versions may be implemented where no hard copies of anything are involved at any time. For instance, in some versions, photographs that are processed in accordance with methods described herein may be originally captured with a digital camera, without any film-based cameras or paper-based prints being involved at any time. Still other versions may include use of images captured by both digital cameras (images transmitted without scanner) and film-based cameras (images converted by scanner then transmitted) to be processed in accordance with methods described herein.

Processor's system (20) in the present example includes a storage device (22) (e.g., one or more servers, etc.), a processor (24), and a user interface (400). User's system (12) and processor's system (20) are remote from one another in this example, though parts of or all of user's system (12) and processor's system (20) may be co-located in some versions. As described in greater detail below, a user at user's system (12) may interface with processor's system (20) via user interface (400) to submit images to processor's system (20). Furthermore, as also described in greater detail below, a user at user's system (12) may perform processing on submitted images in processor's system (20) via user interface (400). As noted above, exchange of data, instructions, etc., between user's system (12) and processor's system (20) may be provided through a network (30) such as the internet. By way of example only, a person or entity associated with processor's system (20) may maintain a web site that a user at user's system (12) may log onto to pull up user interface (400) through a web browser running on user's system (12).

Processing Examples

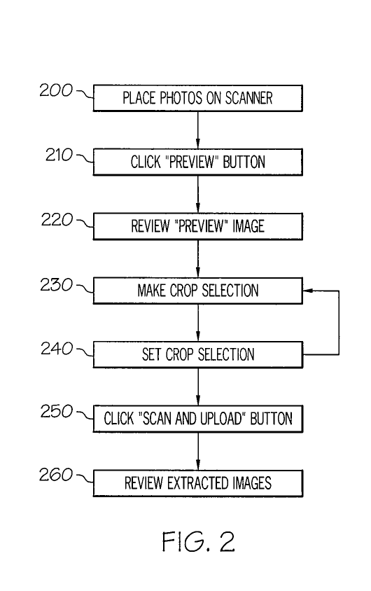

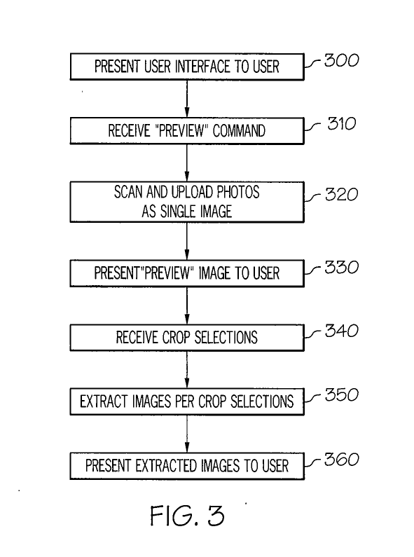

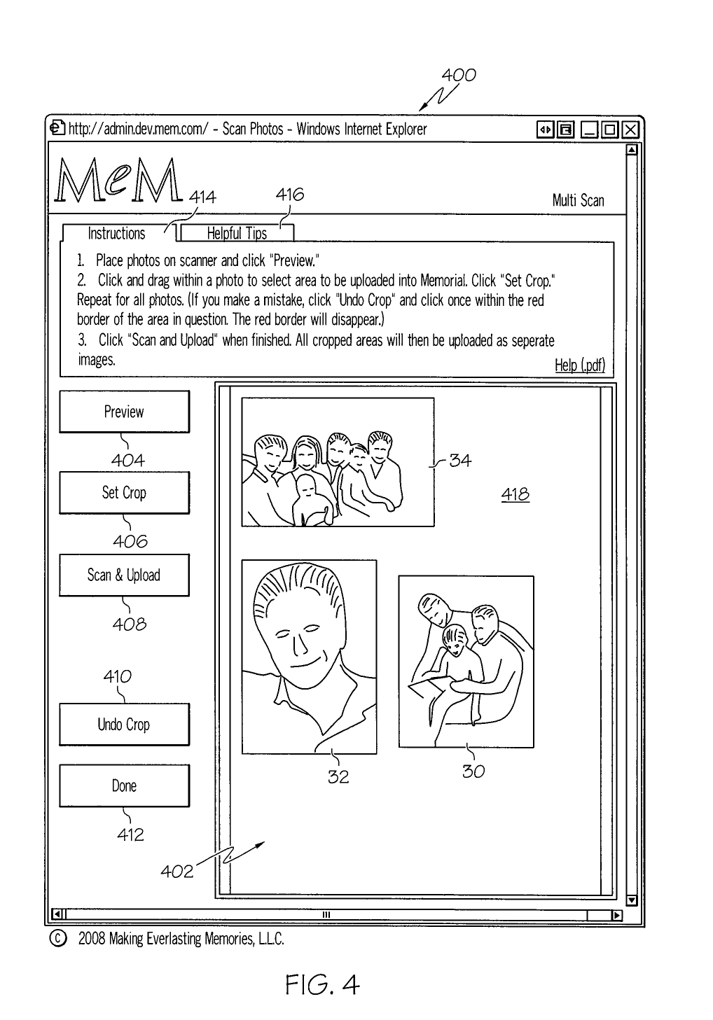

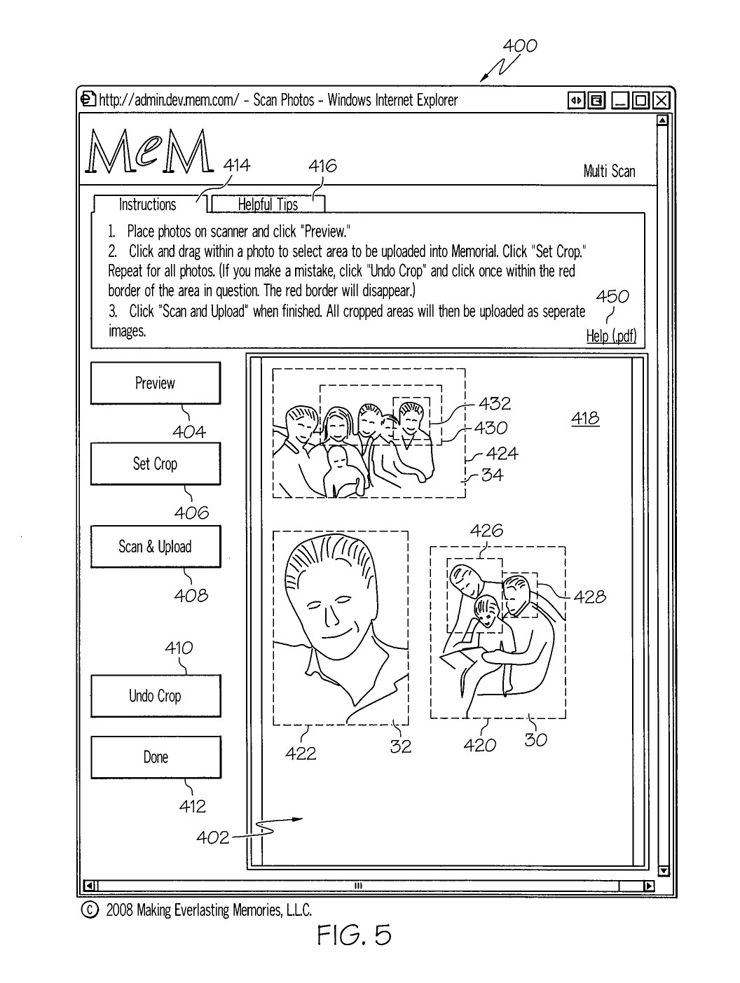

FIGS. 2-3 show some steps that may be performed in accordance with a merely exemplary method of image submission and processing. During performance of this method, the user may interact with user interface (400) as depicted in FIGS. 4-6. As shown in block (200) of FIG. 2, a user at user's system (12) places several photos (30, 32, 34) on scanner (16). The processor's system (20) presents user interface (400) to user (e.g., on computer (14)) via network (30), as shown in block (300) of FIG. 3. As shown in block (210) of FIG. 2, the user may then click on the “preview” button (40), which is shown in FIGS. 4-5. Such clicking may be performed using a mouse or other user input device, as will be apparent to those of ordinary skill in the art in view of the teachings herein. Processor's system (20) may receive the user's click input on the “preview” button (40), as shown in block (310) of FIG. 3, via network (30).

In response to the user clicking on the “preview” button (40), and as shown in block (320) of FIG. 3, the processor's system (20) may remotely command scanner (16) to scan photos (30, 32, 34) that are placed on scanner (16). For instance, such remote commanding may be provided through ActiveX controls running through a web browser on user's system (12). By way of example only, images may be acquired from scanner (16) using software such as “ImagXpress” from Accusoft Pegasus of Tampa, Fla. or similar software. As another merely illustrative example, scanner (16) may be remotely commanded in accordance with the teachings of U.S. Pub. No. 2003/0197721, entitled “Method and System for Creating a Commemorative Presentation,” published Oct. 23, 2003, the disclosure of which is incorporated by reference herein in its entirety. Still other suitable ways in which images may be acquired from scanner (16) will be apparent to those of ordinary skill in the art in view of the teachings herein.

After scanner (16) has scanned photos (30, 32, 34) that are placed on scanner (16), the scanned photos (30, 32, 34) may be automatically uploaded to storage device (22), without the user having to click on a separate “upload” button. In other words, a user's single click on the “preview” button (40) may result in both the scanning and uploading of photos (30, 32, 34) to storage device (22). Such acts of scanning and uploading may be performed substantially contemporaneously. By way of example only, such substantially contemporaneous scanning and uploading may be performed in accordance with the teachings of U.S. Pub. No. 2003/0197721, the disclosure of which is incorporated by reference herein in its entirety. In some versions, photos (30, 32, 34) are uploaded together as a single, collective image file. For instance, photos (30, 32, 34) may be uploaded as a single JPEG file. Alternatively, any other suitable file formats may be used. In addition, photos (30, 32, 34) may be uploaded as more than one image file if desired. Furthermore, user interface (400) may include a separate “upload” button if desired. In other words, the acts of scanning and uploading may be performed separately (from the user's perspective) if desired. Still other ways in which the step represented by block (210) may be varied will be apparent to those of ordinary skill in the art in view of the teachings herein.

In the present example, after photos (30, 32, 34) have been scanned and uploaded, processor's system (20) may then present the scanned and uploaded photos (30, 32, 34) to the user via user interface (400), as shown in block (330) of FIG. 3. In particular, the scanned and uploaded photos (30, 32, 34) may be collectively presented via user interface (40) as a single preview image (418), as shown in FIG. 5. The user may then review the scanned and uploaded photos (30, 32, 34), as shown in block (220) of FIG. 2. During this time, user interface (400) may be configured as shown in FIG. 4, as will be described in greater detail below. Alternatively, user interface (400) may have any other desired configuration.

As shown in block (230) of FIG. 2, the user may then make several crop selections through user interface (400), which may be received by processor's system (20) as shown in block (340) of FIG. 3. Such crop selections may be performed by drawing boxes (420, 422, 424, 426, 428, 430, 432) using a “click, drag, release” operation with a mouse as is known in the art. Alternatively, any other suitable methods or devices may be used to make crop selections. Such selections may be indicated by boxes (420, 422, 424, 426, 428, 430, 432) formed of broken lines, encompassing areas of the preview image (418) that the user would like to extract as separate individual images. By way of example only, the user may draw boxes (420, 422, 424) around the entirety of each individual photograph (30, 32, 34) shown in the preview image (418). After the user draws a box (420, 422, 424, 426, 428, 430, 432) indicating a crop selection, the user may click on the “set crop” button (42), which is shown in FIGS. 4-5, and as indicated in block (240) of FIG. 2, before drawing the next box (420, 422, 424, 426, 428, 430, 432) to indicate the next crop selection.

Alternatively, as with other features described herein, the “set crop” button (42) may be eliminated. For instance, the user may simply draw box (420, 422, 424, 426, 428, 430, 432) after box (420, 422, 424, 426, 428, 430, 432), without clicking on anything between the drawing of boxes (420, 422, 424, 426, 428, 430, 432). In either case, boxes (420, 422, 424, 426, 428, 430, 432) may be adjusted by the user clicking on an edge or corner of the box (420, 422, 424, 426, 428, 430, 432), then dragging the edge or corner to a different location while holding the mouse button down, then releasing the mouse button when the desired location for the edge or corner is reached. Of course, any other suitable devices or techniques may be used to adjust box positioning or box sizing; or to otherwise adjust crop selections.

Furthermore, the user may draw several boxes (424, 430, 432) over a single photograph (34) to make multiple crop selections within photograph (34), such as is shown in FIG. 5. For instance, if photograph (34) depicts several people, the user may make one crop selection to select the entire photograph (34) by drawing a box (424) around the entire photograph (34); then make another crop selection to select just one of the people in the photograph (34) by drawing a box (432) around the one person. A user may make crop selections with overlapping portions, and/or select an area for cropping that is entirely within another area that has been selected for cropping. In the present example, each crop selection will be extracted relative to the originally scanned preview image (418). In other words, if a portion of the preview image (418) is cropped out for one crop selection, the cropped out portion will still be available for subsequent crops, such that one crop will not affect other crops. Other ways in which several crop selections may be made within a preview image (418), including selections of entire photographs and/or portions of photographs within the preview image (418), will be apparent to those of ordinary skill in the art in view of the teachings herein. Furthermore, while crop selections are made using a “click, drag, release” operation with a mouse in the present example, and while crop selections are indicated by boxes (420, 422, 424, 426, 428, 430, 432) formed of broken lines in the present example, it should be understood that crop selections may be made and indicated using any other suitable devices, techniques, and visual aides.

In the present example, after the user has made the desired crop selections, the user may then initiate extraction of images in accordance with the crop selections, as shown in block (250) of FIG. 2. This may be accomplished by clicking on the “scan & upload” button (408) shown in FIGS. 4-5, or in any other suitable fashion. When the user clicks on the “scan & upload” button (408), processor's system (20) may then extract images in accordance with the crop selections, as shown in block (350) of FIG. 3. In particular, processor's system (20) may create (and/or command user's system (12) to create) a plurality of image files (e.g., JPEG files or files of any other suitable format), with each image file providing a view in accordance with one of the crop selections. Following the example provided above, one such image file may provide a view of the entirety of photograph (34), with another separate image file providing a view of just the single person selected in photograph (34). These extracted image files may be saved on storage device (22) or elsewhere. Furthermore, the extracted image files may be tagged with information associating the image files with the user, information indicating a time and date, and/or any other suitable information as will be apparent to those of ordinary skill in the art in view of the teachings herein.

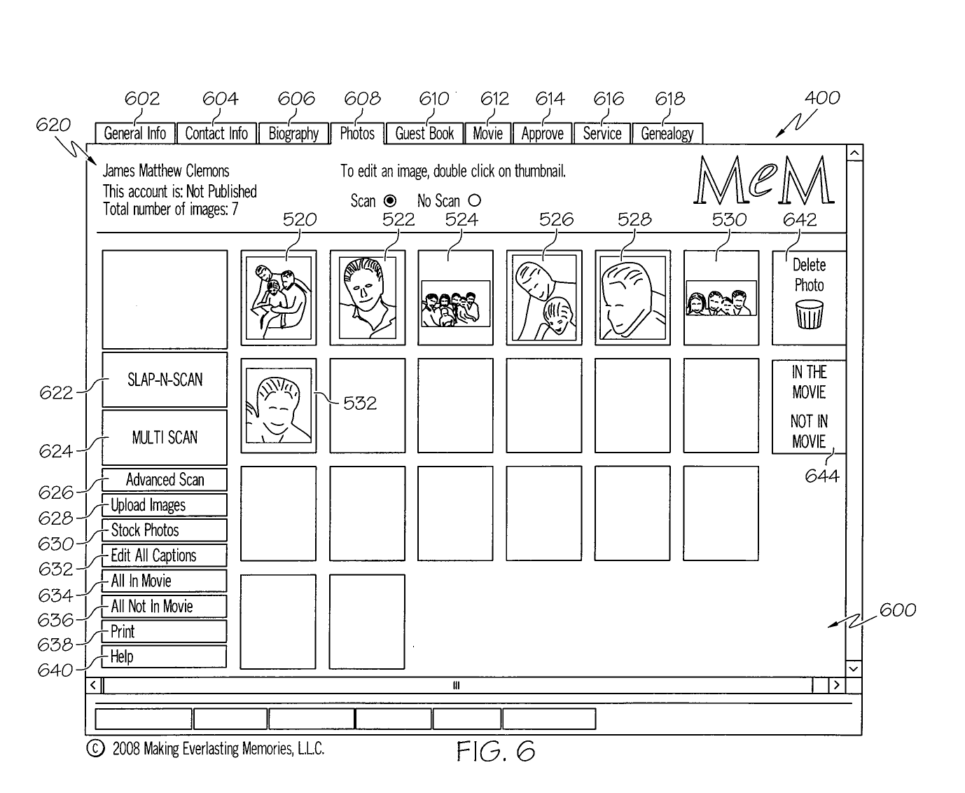

After the images (520, 522, 524, 526, 528, 530, 532) have been extracted, processor's system (20) may present the extracted images (520, 522, 524, 526, 528, 530, 532) to the user, as shown in block (360) of FIG. 3. One merely exemplary configuration of user interface (400) for such presentation is shown in FIG. 6, though any other suitable configuration of user interface (400) for such presentation may be used. In the present example, the extracted images (520, 522, 524, 526, 528, 530, 532) are presented in the same order in which the corresponding crop selections were made. For instance, if a user first selected the entirety of photograph (34) for cropping, then selected the image of just a single person depicted within photograph (34) for cropping, user interface (400) may present an image of the entirety of photograph (34) first, then present a cropped image of just the single depicted within photograph (34), etc. Alternatively, extracted images may be presented in any other suitable order. User interface (400) may also permit the user to re-order images (520, 522, 524, 526, 528, 530, 532), such as with a “drag and drop” operation of a mouse or using any other suitable devices or techniques. The user may then review the extracted images, as shown in block (260) of FIG. 2. The user may repeat the above processes until all of the desired photos are scanned and all of the desired crop selections are made and submitted.

It should be understood that the foregoing methods may be performed with just a single image file being transmitted from user's system (12) to processor's system (20), with the final result being a plurality of images stored on processor's system (20). In particular, the single transmitted image file in this example is the single image file created by the scanning of several photographs (30, 32, 34) on scanner (16) in accordance with block (320). After that single image file has been transmitted from user's system (12) to processor's system (20), the image files created in accordance with block (350) are stored in storage device (22) of processor's system (20), without those image files being fully transmitted back to user's system (12) for storage thereon. Of course, at least a portion of image files may be stored at least temporarily on user's system (12) to permit display of images through a web browser on user's system (12). In any event, the use of storage space on user's computer (14) is minimized in this particular example. Alternatively, use of memory or other storage may be allocated among user's system (12) and processor's system (20) in any other desired fashion, including any desired use of components within user's system (12) and processor's system (20).

It should also be understood that the foregoing methods may be performed with the majority of the data processing being performed on processor's system (20) (e.g., on processor (24)). In particular, processor (24) may initiate and provide the instructions to cause scanner (16) to scan photos, may cause the preview image (418) to be stored on storage device (22), may receive and process a user's crop selections, may effect the crop selections by creating a plurality of images from the “preview” image and cause those images to be stored on storage device (22), etc. Thus, from a data processing standpoint, user's computer (14) may simply be used for entry of selections and commands, and for display of user interface (400) on a web browser. The use of processing resources on user's computer (14) is therefore minimized in this example. Alternatively, data processing may be allocated among user's system (12) and processor's system (20) in any other desired fashion, including any desired use of components within user's system (12) and processor's system (20).

Any of the processing steps, or parts thereof, that are described herein may be performed using software (or components of software) such as “ImagXpress” from Accusoft Pegasus of Tampa, Fla. and/or “ImageUploader” from Aurigma Inc. of Alexandria, Va. Various ways in which such software (or components of such software) may be used to perform any of the processing steps, or parts thereof, that are described herein will be apparent to those of ordinary skill in the art in view of the teachings herein. By way of example only, “ImageUploader” software (or components of such software) may be used to provide a temporary directory on user's computer (14) to temporarily store images between steps of cropping and uploading/extraction and/or to automatically upload images to storage device (22); while “ImagXpress” software (or components of such software) may be used to acquire images from scanner (16) and/or provide preview pane (402) to permit the user to make crop selections and/or perform selected cropping and/or save cropped images to a temporary directory that was determined by or otherwise provided by “ImageUploader” software. Alternatively, such software may be used in any other suitable fashion. Furthermore, any other suitable software or components of software (including pre-existing software or custom software) may be used to carry out any of the processing steps (or parts thereof) described herein.

User Interface Examples

As noted above, FIGS. 4-6 depict examples of user interface (400) throughout several phases of methods described herein. As shown in FIGS. 4-5, user interface (400) of the present example includes a preview pane (402), a “preview” button (404), a “set crop” button (406), a “scan & upload” button (408), an “undo crop” button (410), and a “done” button (412). User interface also includes an “instructions” tab (414) and a “helpful tips” tab (416). User interface (400) is configured to be displayed through a web browser on user's computer (14) in this example. Alternatively, user interface (400) may be presented to a user in any other suitable fashion. Furthermore, while certain features of user interface (400) are noted above and will be described in greater detail below, it should be understood that each and every one of these features is merely optional. Any of the features may be omitted, substituted, supplemented, rearranged, or varied as desired.

In the present example, “instructions” tab (414) includes a brief set of instructions for a user interacting with user interface (400). The “instructions” tab also includes a link (450) to a help file. For instance, the help file may include a document (e.g., a .pdf file) listing answers to frequently asked questions, providing further instructions, etc. The “helpful tips” tab (416) may provide additional tips to the user when the user clicks on the “helpful tips” tab (416). Of course, these tabs (414, 416) are merely optional.

Preview pane (402) as shown in FIGS. 4-5 displays a preview image (418), which includes scanned photographs (30, 32, 34). As discussed above with reference to block (210) of FIG. 2 and block (310) of FIG. 3, preview image (418) may be generated by a user clicking on the “preview” button (404) after photographs (30, 32, 34) have been placed on scanner (16). This single click causes scanner (16) to scan photographs (30, 32, 34) into a preview image (418) and automatically upload the preview image (418) of scanned photographs (30, 32, 34) to processor's system (20) as a single image file, as discussed above with reference to block (320) of FIG. 3. With preview image (418) being presented to the user via preview pane (402), as discussed above with reference to block (330) of FIG. 3, the user may then review preview image (418), as discussed above with reference to block (220) of FIG. 2. Before the user clicks on the “preview” button (404) (e.g., before any photographs (30, 32, 34) are scanned by scanner (16)), preview pane (402) may simply be blank.

As discussed above with reference to blocks (230, 240) of FIG. 2, the user may then make and set several crop selections within preview image (418) via user interface (400). In particular, the user may draw several boxes (420, 422, 424, 426, 428, 430, 432) within preview image (418). As shown in FIG. 5, each box (420, 422, 424) corresponds with the entirety of each photograph (30, 32, 34), respectively. Boxes (426, 428) correspond with areas within photograph (30); while boxes (430, 432) correspond with areas within photograph (34). It should be noted that boxes may be adjacent one another, such as boxes (426, 428); that a box may be “nested” within another box, such as boxes (432, 430); that the perimeters of boxes may intersect one another; or that boxes may have any other suitable relationships or arrangements relative to one another. Indeed, in the present example, boxes (420, 422, 424, 426, 428, 430, 432) are independent of one another, both in terms of how they are created and in terms of their effect. Of course, boxes (420, 422, 424, 426, 428, 430, 432) are merely one of many possible ways in which crop selections may be indicated. Other ways in which crop selections may be indicated will be apparent to those of ordinary skill in the art in view of the teachings herein.

In the present example, and as noted above, when drawing boxes (420, 422, 424, 426, 428, 430, 432), the user uses a “click, drag, release” operation of a mouse at user's computer (14). In particular, the user uses the mouse to draw the first box (420). The user then clicks on the “set crop” button (406). If the user desires to move, resize, or reshape box (420), the user may do so before clicking on the “set crop” button (406). While box (420) is being drawn and adjusted, it will appear in broken lines in the present example. The lines defining box (420) may turn into solid lines after the “set crop” button (406) has been clicked on for that crop. After the “set crop” button (406) has been clicked on, the user may draw the next box (422), then click on the “set crop” button (406) again before drawing the next box (424). This process may be repeated until the remaining boxes (424, 426, 428, 430, 432) are drawn to enter crop selections, which will be received by processor's system (20) as described above with respect to block (340) of FIG. 3. Of course, crop selections may be made and entered in a variety of other ways, any of which would be suitable.

Upon entering crop selections, the user may decide that they no longer wish to make a crop that has been entered. In order to correct this, the user may click on the “undo crop” button (410). After clicking on “undo crop” button (410), the user may then click on the perimeter of the box (420, 422, 424, 426, 428, 430, 432) that shows the crop selection that is no longer desired. This will then cause that particular box (420, 422, 424, 426, 428, 430, 432) to disappear. This process may be repeated until all undesired crop selections are removed. Alternatively, the user may first click on the perimeter of a box (420, 422, 424, 426, 428, 430, 432) that is no longer desired, them click on the “undo crop” button (410) to eliminate the corresponding crop selection. As with other features of user interface (400), “undo crop” button (410) is merely optional, and may be omitted, substituted, supplemented, or varied as desired.

After all desired crop selections have been made, the user may then click on the “scan & upload” button (408) to extract images from the preview image (402) in accordance with the crop selections, as described above with reference to block (250) of FIG. 2. In the present example, nothing is actually scanned or uploaded in response to the user clicking on the “scan & upload” button (408). Indeed, preview image (402) already resides on storage device (22) of processor's system (20) at that point. Instead, processor's system (20) simply copies the cropped regions from preview image (402), and stores a copy of each cropped region as a separate image file on storage device (22). In other words, an image (520) corresponding with box (420) is stored as one image file on storage device (22); an image (522) corresponding with box (422) is stored as another image file on storage device (22); and so on, until each box (420, 422, 424, 426, 428, 430, 432) is essentially converted into a separate corresponding image (520, 522, 524, 526, 528, 530, 532) and stored as a separate corresponding image file on storage device (22).

In some other variations, preview image (402) is stored on user's computer (14). In some such variations, when a user clicks on the “scan & upload” button (408), separate images (520, 522, 524, 526, 528, 530, 532) corresponding with boxes (420, 422, 424, 426, 428, 430, 432) are created on user's computer (14), and are then uploaded as separate files to processor's system (20) for storage on storage device (22). Some time after copies of those separate files have been uploaded to processor's system (20), they may be deleted from user's computer (14). Alternatively, any other suitable processing methods may be used, including those using different allocations of processing steps and/or storage procedures among user's system (14), processor's system (20), and/or any other system or device.

After images (520, 522, 524, 526, 528, 530, 532) corresponding with boxes (420, 422, 424, 426, 428, 430, 432) have been extracted from preview image (402) in the present example, processor's system (20) may present images (520, 522, 524, 526, 528, 530, 532) to the user as described above with reference to block (360) of FIG. 3. The user may then review images (520, 522, 524, 526, 528, 530, 532) as described above with reference to block (260) of FIG. 2.

FIG. 6 depicts one merely illustrative example of a configuration for user interface (400) in which images (520, 522, 524, 526, 528, 530, 532) are presented to the user for review. User interface (400) as shown in FIG. 6 includes a plurality of tabs, including a “general info” tab (602), a “contact info” tab (604), a “biography” tab (606), a “photos” tab (608), a “guest book” tab (610), a “movie” tab (612), an “approve” tab (614), a “service” tab (616), and a “genealogy” tab (618). Of course, these tabs (602, 604, 606, 608, 610, 612, 614, 616, 618) are merely exemplary, and any one of them may be omitted, substituted, supplemented, or varied as desired.

As shown in FIG. 6, images (520, 522, 524, 526, 528, 530, 532) are displayed as thumbnail images through the “photos” tab (608). As shown in FIG. 6, “photos” tab (608) includes an image preview pane (600). Image preview pane (600) displays thumbnails of images (520, 522, 524, 526, 528, 530, 532) in the order in which the corresponding crop selections were entered. In other words, since box (420) was drawn first, its corresponding image (520) is displayed as the first image in the series of images (520, 522, 524, 526, 528, 530, 532). Box (422) was drawn second, so its corresponding image (522) is displayed as the second image in the series of images (520, 522, 524, 526, 528, 530, 532), and so on. Of course, images (520, 522, 524, 526, 528, 530, 532) may alternatively be provided in any other desired order or arrangement. User interface (400) may also permit a user to rearrange images (520, 522, 524, 526, 528, 530, 532) within image preview pane (600) through “drag and drop” operations of a mouse, or using any other suitable devices or techniques. Furthermore, images (520, 522, 524, 526, 528, 530, 532) need not necessarily be all shown on the same screen. Other suitable ways in which images (520, 522, 524, 526, 528, 530, 532) may be presented to the user will be apparent to those of ordinary skill in the art in view of the teachings herein.

In some implementations, and as described above, user interface (400) may essentially transition from the version shown in FIG. 5 to the version shown in FIG. 6 after the user has made their crop selections and has clicked on the “scan & upload” button (408). In the present example, as the cropped images (520, 522, 524, 526, 528, 530, 532) are being extracted from preview image (418), user interface (400) may present the user with a progress bar or other indication of progress and/or may present the user with a thumbnail view of each image (520, 522, 524, 526, 528, 530, 532) individually as the process progresses. By way of example only, such a progress bar and succession of individual thumbnail views may be shown as an overlay over the version of user interface (400) shown in FIG. 5, with user interface (400) transitioning to the version shown in FIG. 6 after all images (520, 522, 524, 526, 528, 530, 532) have been extracted. Alternatively, user interface (400) may transition from the version shown in FIG. 5 to the version shown in FIG. 6 right after the user has made their crop selections and has clicked on the “scan & upload” button (408), and the above-described progress bar and succession of individual thumbnail views may be shown as an overlay over the version of user interface (400) shown in FIG. 6. In this example, thumbnail views of each image (520) may first be shown in the overlay, and then the thumbnail view of image (520) may be shown in image pane (600) as the next image (522) is shown in the overlay, and so on, until each image (520, 522, 524, 526, 528, 530, 532) has been successively shown temporarily in an overlay and then populated into image pane (600). Alternatively, the progress of “scan & upload” operation and/or other aspects of extraction of images (520, 522, 524, 526, 528, 530, 532) may be shown in any other suitable fashion, if at all.

“Photos” tab (608) of the present example also includes an information pane (620), a “slap-n-scan” button (622), a “multi scan” button (624), an “advanced scan” button (626), an “upload images” button (628), a “stock photos” button (630), an “edit all captions” button (632), an “all in movie” button (634), an “all not in movie” button (636), a “print” button (638), and a “help” button (640). In addition, “photos” tab (608) includes a “delete photo” box (642) and a movie indicator box (644). As with other features of any component described herein, all of these features of “photos” tab (608) are mere examples. Any such features may be omitted, substituted, supplemented, or varied as desired.

In some versions, the user at user's system (12) has set up an account with a processor at processor's system (20). For instance, the processor may be a service provider who publishes content online, as will be described in greater detail below. Information pane (620) in this example includes a brief amount of information about the user's account, such as the account holders name, whether content associated with the account has been published, etc.

“Slap-n-scan” button (622) in the present example is operable to permit the user to perform both scanning of a photograph with scanner (16) and uploading the scanned image to processor's system (20), all with the single click of a button. The scanning and uploading may thus occur substantially simultaneously. In other words, the user does not need to click once to scan the photo and again to upload the scanned photo. One click will cause both scanning and uploading. Such “one-click” scanning and uploading is described in greater detail in U.S. Pub. No. 2003/0197721, entitled “Method and System for Creating a Commemorative Presentation,” published Oct. 23, 2003, the disclosure of which is incorporated by reference herein in its entirety. During such scanning and uploading, user interface (400) may optionally present the user with a progress bar or otherwise provide an indication of progress to the user. To the extent that one or more images are already in image pane (600), the user may add more images by clicking on the “slap-n-scan” button (622). Doing so may simply result in more images being added to image pane (600), following images (520, 522, 524, 526, 528, 530, 532) that are already in image pane (600).

“Multi-scan” button (624) in the present example is operable to direct the user to the version of user interface (400) shown in FIGS. 4-5. In other words, a user may click on the “multi scan” button (624), which will link the user to a page having the features shown in FIGS. 4-5 and described above. To the extent that one or more images are already in image pane (600), the user may add more images by clicking on the “multi scan” button (624) and going through the processes described above with reference to FIGS. 2-5. Doing so may simply result in more images being added to image pane (600), following images (520, 522, 524, 526, 528, 530, 532) that are already in image pane (600).

“Advanced scan” button (626) permits the user to perform additional image processing, on a per-image basis. For instance, “advanced scan” button (626) may provide the user options to adjust the size of images, adjust orientation of images, perform auto-cropping, perform auto-despeckling, perform auto-contrast adjustment, etc., one image at a time. In some versions, such adjustments are set before any images are scanned. In some other versions, such adjustments are set after images have been scanned. In still other versions, “advanced scan” button (626) is simply omitted altogether. It should therefore be understood that, like “advanced scan” button (626), any other features of user interface (400) described herein are merely optional; and that any such features may be omitted or varied as desired, and that other features may be added to user interface (400) as desired.

“Upload images” button (628) permits the user to access images that are already stored locally relative to user's system (12). For instance, “upload images” button (628) may permit the user to access images that are already stored on the hard drive of user's computer (14), access images that are already stored on a CD-ROM or DVD-ROM at user's computer (14), access images that are already stored on a flash drive at user's computer (14), etc. To the extent that user's system (12) has access to one or more images on some other computer system (e.g., a remote server, a computer coupled with user's computer (14) via a LAN/WAN, etc.), “upload images” button (628) may also permit the user to access such other images. In any such case, the user may upload such pre-stored images to processor's system (20) by using “upload images” button (628) of the present example.

“Stock photos” button (630) permits the user to access several stock images. For instance, storage device (22) may store a plurality of stock images that existed before the user at user's system (12) ever started interacting with image processing system (10). Such stock images may thus have nothing personally to do with the user at user's system (12) or with any friend or relative of the user at user's system (12). The user may nevertheless wish to incorporate one or more stock images among images (520, 522, 524, 526, 528, 530, 532). Such stock images may be added to image preview pane (600) in any suitable fashion.

In some versions, one or more of images (520, 522, 524, 526, 528, 530, 532) include captions. Such captions may be written or edited individually or collectively. “Edit all captions” button (632) permits the user to edit the captions of images (520, 522, 524, 526, 528, 530, 532) collectively. In other words, “edit all captions” button (632) may be used to edit the captions for all images (520, 522, 524, 526, 528, 530, 532) at once rather than edit the caption for each image (520, 522, 524, 526, 528, 530, 532) individually.

In some versions, and as described in greater detail below, images (520, 522, 524, 526, 528, 530, 532) may be incorporated into a movie. For instance, systems and methods of creating and streaming a movie simultaneously or “on the fly” are described in U.S. Pub. No. 2003/0197721, the disclosure of which is incorporated by reference herein. “All in movie” button (634) permits the user to automatically have all of images (520, 522, 524, 526, 528, 530, 532) incorporated into such a movie. “All not in movie” button (636) permits the user to remove all of images (520, 522, 524, 526, 528, 530, 532) from inclusion in such a movie.

“Print” button (638) permits the user to print one or more of images (520, 522, 524, 526, 528, 530, 532). In some versions, the user must select which of images (520, 522, 524, 526, 528, 530, 532) the user would like to print, and the selected image will be printed at user's system (12) when the user clicks on “print” button (638). Alternatively, all images (520, 522, 524, 526, 528, 530, 532) in image pane (600) may be printed when the user clicks on “print” button (638), such that selection of specific images (520, 522, 524, 526, 528, 530, 532) for printing is not necessary.

“Help” button (640) is operable to provide instructional information to the user. For instance, clicking on “help” button (640) may cause an instructional document to open or otherwise provide instructional text. Alternatively, clicking on “help” button (640) may open an instant messaging window, initiate an e-mail, or otherwise result in some form of assistance to the user.

“Delete photo” box (642) permits the user to delete any of images (520, 522, 524, 526, 528, 530, 532) from image pane (600). For instance, the user may simply “drag” an undesired image (520, 522, 524, 526, 528, 530, 532) to “delete photo” box (642) and “drop” the undesired image (520, 522, 524, 526, 528, 530, 532) there.

Movie indicator box (644) permits the user to determine whether any of images (520, 522, 524, 526, 528, 530, 532) have been designated for inclusion in the movie associated with “movie” tab (612). As shown, movie indicator box (64) includes an “In the Movie” text field and a “Not in Movie” text field. When the user clicks on one of images (520, 522, 524, 526, 528, 530, 532), one of those two text fields in the movie indicator box (644) may be illuminated, change color, or provide some other visual indication as to whether the selected image is designated for inclusion in the movie. In addition or in the alternative, movie indicator box (644) may be configured to permit the user to selectively include or exclude images (520, 522, 524, 526, 528, 530, 532) into or from a movie, by allowing the user to selectively “drag and drop” one or more selected images onto the “In the Movie” text field or the “Not in Movie” text field. A user may also be permitted to designate one or more of images (520, 522, 524, 526, 528, 530, 532) for inclusion in or exclusion from a movie as part of a right-click menu. In other words, a user may select one or more of images (520, 522, 524, 526, 528, 530, 532) using a mouse at user's computer (14), then hit the right-click button on the mouse to bring up a pop-up menu. Such a menu may include options permitting the user to designate the selected one or more images (520, 522, 524, 526, 528, 530, 532) for inclusion in or exclusion from a movie. Alternatively, one or more images (520, 522, 524, 526, 528, 530, 532) may be designated for inclusion in or exclusion from a movie in any other suitable fashion. Similarly, any suitable variation of or alternative to movie indicator box (64) may be used to indicate whether one or more images (520, 522, 524, 526, 528, 530, 532) have been designated for inclusion in or exclusion from a movie. Of course, as with any other feature of user interface (400) described herein, movie indicator box (644) may simply be omitted altogether, if desired.

It should be clearly understood that all of the features of user interface (400) as shown in FIGS. 4-6 and as described above are just examples. Any one of those features may be omitted, substituted, supplemented, rearranged, or varied as desired. Accordingly, nothing in the specification or drawings should be read as requiring any particular type of user interface (400), or of requiring any particular feature or configuration of a user interface (400).

Exemplary Combinations with Other Systems and Methods

In some versions, image processing system (10) and everything else described herein is at least partially incorporated into a system or method as described in U.S. Pat. No. 7,287,225, entitled “Method and Apparatus for Presenting Linked Life Stories,” issued Oct. 23, 2007, the disclosure of which is incorporated by reference herein in its entirety. For instance, U.S. Pat. No. 7,287,225 describes how various “recordations,” including photographs and other images, may be used to tell the life story of a living person and/or a deceased person. Thus, image processing system (10) and methods described herein may be used to create and/or submit images for use in the systems and methods described in U.S. Pat. No. 7,287,225. In other words, and by way of example only, images (520, 522, 524, 526, 528, 530, 532) may be used as “recordations” (possibly among a variety of other types of “recordations”) as part of a person's life story as disclosed in U.S. Pat. No. 7,287,225. Images (520, 522, 524, 526, 528, 530, 532) may be used as separate images and/or as combined in a movie to tell a person's life story. To the extent that a processing entity provides and maintains processor's system (20), that same entity may maintain the system of recordations and life stories disclosed in U.S. Pat. No. 7,287,225.

In one exemplary combination of image processing system (10) and the systems and methods described in U.S. Pat. No. 7,287,225, a user at user's system (12) is a friend or relative of a deceased person, and images (520, 522, 524, 526, 528, 530, 532) relate to the deceased person. In other implementations, a funeral service provider is the user at user's system (12). Thus, the friend or relative of the deceased person may provide hard copies of photographs (30, 32, 34) to the funeral service provider, and the funeral service provider may scan the photographs (30, 32, 34) and perform other acts of the methods described herein.

Referring back to FIG. 6 in the context of a combination with the teachings in U.S. Pat. No. 7,287,225, “general info” tab (602) may include general information about the deceased person and/or the living friend or relative of the deceased person. “Contact info” tab (604) may include contact information for the living friend or relative of the deceased person. “Biography” tab (606) may include biographical information about the deceased person. For instance, such a biography may be written at least in part by the living friend or relative of the deceased person. Alternatively, as noted below, at least part of the biography appearing on “biography” tab (606) may be automatically generated as described in U.S. Pub. No. 2008/0005666, the disclosure of which is incorporated by reference herein.

“Guest book” tab (610) may include a list of people who have visited a website for the deceased person that provides access to the recordations and life story for the deceased person. In addition or in the alternative, “guest book” tab (610) may list people who attended an in-person funeral or other memorial service for the deceased person. “Movie” tab (612) may provide access to a movie relating to the deceased person. For instance, such a movie may include any number of images (520, 522, 524, 526, 528, 530, 532). Thus, a movie may be created, edited, and/or otherwise accessed through “movie” tab (612). As noted below, such a movie may also be created and streamed simultaneously or “on the fly,” as described in U.S. Pub. No. 2003/0197721, the disclosure of which is incorporated by reference herein. Features of “movie” tab (612) may permit selection of photos, video clips, audio, voice-overs, text, and/or any other types of information or content for inclusion in a movie.

It will be appreciated in view of the teachings herein that a profile may be associated with a deceased person, and the profile may be associated with a variety of recordations. Furthermore, access to such recordations and other content may be provided to a variety of users (42). “Approve” tab (614) may provide the user at user's system (12) the option to approve content and recordations for accessing by users (42). “Service” tab (616) may have information about a funeral service or memorial service for the deceased person (e.g., time, date, location, etc.). “Genealogy” tab (618) may include genealogical information relating to the deceased person.

Of course, the systems and methods described herein may have nothing to do with any deceased persons in some implementations, and may instead relate to only living persons or both deceased persons and living persons. Furthermore, images (520, 522, 524, 526, 528, 530, 532) may relate to a non-human entity, place, event, etc., and need not necessarily relate to a particular person at all.

As noted above, a plurality of other users (42) may be given access to the above-noted recordations and life stories via network (30), such as is described in U.S. Pat. No. 7,287,225. Thus, several users (42) other than a user at user's system (12) may be able to view at least some of images (520, 522, 524, 526, 528, 530, 532) via network (30). Still other ways in which the teachings herein and the teachings in U.S. Pat. No. 7,287,225 may be combined will be apparent to those of ordinary skill in the art. Indeed, every possible combination and permutation of the teachings herein and the teachings in U.S. Pat. No. 7,287,225 is contemplated by the inventors. Ways in which such combinations and permutations may be carried out will be apparent to those of ordinary skill in the art in view of the teachings herein.

Similarly, in some versions, image processing system (10) and everything else described herein is at least partially incorporated into a system or method as described in U.S. Pat. No. 7,222,120, entitled “Methods of Providing a Registry Service and a Registry Service,” issued May 22, 2007, the disclosure of which is incorporated by reference herein in its entirety. For instance, U.S. Pat. No. 7,222,120 describes how an online registry system may provide information on a living person and/or a deceased person and/or any other entity, etc. Thus, image processing system (10) and methods described herein may be used to create and/or submit images for use in the systems and methods described in U.S. Pat. No. 7,287,225. In other words, and by way of example only, images (520, 522, 524, 526, 528, 530, 532) may be used as information (possibly among a variety of other types of information) as part of a registry entry for a person or entity as disclosed in U.S. Pat. No. 7,222,120. Thus, as noted above in the context of U.S. Pat. No. 7,287,225, several users (42) other than a user at user's system (12) may be able to view at least some of images (520, 522, 524, 526, 528, 530, 532) via network (30) as part of a registry entry as contemplated in U.S. Pat. No. 7,222,120. Still other ways in which the teachings herein and the teachings in U.S. Pat. No. 7,222,120 may be combined will be apparent to those of ordinary skill in the art. Indeed, every possible combination and permutation of the teachings herein and the teachings in U.S. Pat. No. 7,222,120 is contemplated by the inventors. Ways in which such combinations and permutations may be carried out will be apparent to those of ordinary skill in the art in view of the teachings herein.

It should also be understood that any teachings in U.S. Pub. No. 2003/0197721 could be incorporated into the systems and methods described herein; and that any teachings herein could be incorporated into the systems and methods described in U.S. Pub. No. 2003/0197721. Such interchangeability of teachings is not limited to “one-click” scanning and uploading as noted above, but extends to everything taught herein and in U.S. Pub. No. 2003/0197721. For instance, U.S. Pub. No. 2003/0197721 teaches how a movie (e.g., a slideshow) may be created and streamed to a remote user simultaneously or “on the fly,” using a plurality of still photos (e.g., “photos” in some contexts meaning images that were captured at completely different moments in time, such as different years, as opposed to frames of a movie that were captured at immediately adjacent moments in time). Images (520, 522, 524, 526, 528, 530, 532) that are created as described herein may form part of such an “on the fly” movie as described in U.S. Pub. No. 2003/0197721. As noted above, such a movie may be created, edited, and/or otherwise accessed through “movie” tab (612) of the user interface (400) shown in FIG. 6. Every other possible combination and permutation of the teachings herein and the teachings in U.S. Pub. No. 2003/0197721 is contemplated by the inventors. Ways in which such combinations and permutations may be carried out will be apparent to those of ordinary skill in the art in view of the teachings herein.

In some other versions, image processing system (10) and everything else described herein is at least partially incorporated into a system or method as described in U.S. Pub. No. 2006/0125930, entitled “Image Capture and Distribution System and Method,” published Jun. 15, 2006, the disclosure of which is incorporated by reference herein in its entirety. For instance, U.S. Pub. No. 2006/0125930 describes how a product may be created using one or more images selected by a user. Thus, image processing system (10) and methods described herein may be used to create and/or submit images for use in the systems and methods described in U.S. Pub. No. 2006/0125930. In other words, and by way of example only, images (520, 522, 524, 526, 528, 530, 532) may be part of a compiled image set as disclosed in U.S. Pub. No. 2006/0125930. Still other ways in which the teachings herein and the teachings in U.S. Pub. No. 2006/0125930 may be combined will be apparent to those of ordinary skill in the art. Indeed, every possible combination and permutation of the teachings herein and the teachings in U.S. Pub. No. 2006/0125930 is contemplated by the inventors. Ways in which such combinations and permutations may be carried out will be apparent to those of ordinary skill in the art in view of the teachings herein.

In still other versions, image processing system (10) and everything else described herein is at least partially incorporated into a system or method as described in U.S. Pub. No. 2008/0005666, entitled “System and Method for Publishing Information and Content,” published Jan. 3, 2008, the disclosure of which is incorporated by reference herein in its entirety. For instance, U.S. Pub. No. 2008/0005666 describes how a publisher may render various types of outputs using any number of a variety of types of inputs. Thus, image processing system (10) and methods described herein may be used to create and/or submit images for use in the systems and methods described in U.S. Pub. No. 2006/0125930. In other words, and by way of example only, images (520, 522, 524, 526, 528, 530, 532) may be part of the pool of inputs as disclosed in U.S. Pub. No. 2008/0005666. Furthermore, U.S. Pub. No. 2008/0005666 describes how a biography may be automatically generated based on one or more inputs. Such an automatically generated biography may appear at least in part on the “biography” tab (606) of FIG. 6. Still other ways in which the teachings herein and the teachings in U.S. Pub. No. 2008/0005666 may be combined will be apparent to those of ordinary skill in the art. Indeed, every possible combination and permutation of the teachings herein and the teachings in U.S. Pub. No. 2008/0005666 is contemplated by the inventors. Ways in which such combinations and permutations may be carried out will be apparent to those of ordinary skill in the art in view of the teachings herein.

Several examples disclosed herein include implementations where a user's system (12) is coupled with a remote processor's system (20). It should be understood, however, that some other implementations may be purely local. For instance, any of the processing steps described herein may be carried out on user's system (12) alone. Indeed, processes described herein may be carried out on user's system (12) without user's system even being coupled with a network (30). By way of example only, a locally stored image processing program on user's computer (14) may include features operable to extract several images (520, 522, 524, 526, 528, 530, 532) from a single preview image (418) in accordance with a user's crop selections as described above. Suitable ways in which such features may be locally provided on user's computer (14) will be apparent to those of ordinary skill in the art in view of the teachings herein. Furthermore, features described herein may be integrated into a preexisting image processing program residing on user's computer (14). For instance, features described herein may be provided as a macro tool or add-on in a preexisting image processing program residing on user's computer (14). It is therefore contemplated that features and processes described herein may be implemented in any way possible, including any possible allocation of software, storage, processing, etc. among user's system (12), processor's system (20), and/or any suitable combination thereof. This disclosure should therefore not be read as requiring any particular allocation of software, storage, processing, etc. among user's system (12) and processor's system (20) unless otherwise explicitly recited in the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A method of processing images, the method comprising:
(a) presenting a user interface to a remote user via a network, wherein the remote user has a computer configured to display the user interface;
(b) receiving a preview command from the user;
(c) initiating a scanning process at a scanner coupled with the user's computer, wherein the act of initiating a scanning process is performed in response to receiving the preview command, wherein the act of initiating is performed from a location remote to the user;
(d) receiving a single scanned image obtained through the scanner;
(e) receiving a plurality of crop selections from the user, wherein the crop selections are made within the single scanned image by the user; and
(f) creating a plurality of image files based on the crop selections.

2. The method of claim 1, wherein the network is the internet.

3. The method of claim 1, wherein the user interface is presented through a web browser on the user's computer.

4. The method of claim 1, wherein the user interface has a preview button, wherein the preview command is initiated by the user clicking on the preview button.

5. The method of claim 4, wherein the act of receiving the single scanned image comprises uploading the scanned image from the user's computer via the network.

6. The method of claim 5, wherein the act of initiating the scanning process and the act of uploading the single scanned image are both performed in response to a single click of the user on the preview button.

7. The method of claim 1, wherein the crop selections are defined by a plurality of boxes drawn by the user within the single scanned image, wherein the boxes surround different portions of the single scanned image.

8. The method of claim 7, wherein the created image files provide respective views of the portions of the scanned image within the boxes drawn by the user.

9. The method of claim 1, wherein the user interface has an image extraction button, wherein the act of creating a plurality of image files is performed in response to a single click on the image extraction button.

10. The method of claim 1, further comprising storing the plurality of image files on a storage device remote from the user's computer.

11. The method of claim 1, wherein the single scanned image includes a plurality of photographs.

12. The method of claim 11, wherein the crop selections are made within each photograph of the plurality of photographs.

13. A method of processing images, the method comprising:
(a) viewing a user interface on a computer, wherein the user interface is presented by a remote computer system via a network;
(b) positioning one or more photographs relative to a scanner;
(c) initiating a preview command through the user interface, wherein the initiated preview command causes the scanner to scan the one or more photographs as a scanned image;
(d) transmitting the scanned image to the remote computer system;
(e) making a plurality of crop selections within the scanned image through the user interface; and
(f) initiating creation of a plurality of image files based on the crop selections, wherein the act of initiating creation of a plurality of image files is performed after the plurality of crop selections have been made.

14. The method of claim 13, wherein the network is the internet, wherein the act of viewing the user interface is performed using a web browser.

15. The method of claim 13, wherein the user interface has a preview button, wherein the act of initiating a preview command comprises clicking on the preview button.

16. The method of claim 13, wherein the act of making a plurality of crop selections comprises drawing a plurality of boxes within the scanned image through the user interface.

17. The method of claim 13, wherein the scanner comprises a flatbed scanner, wherein the act of positioning one or more photographs relative to a scanner comprises positioning a plurality of hard copy photographs on the flatbed scanner.

18. The method of claim 13, wherein the user interface has an image extraction button, wherein the act of initiating creation of a plurality of image files comprises clicking on the image extraction button, wherein the plurality of image files are created in response to a single click on the image extraction button.

19. A system for processing images, the system comprising:
(a) a processor's computer system, wherein the processor's system is remote from a user's computer, wherein the processor's system is in communication with the user's computer via a network; and
(b) a user interface, wherein the user interface is provided by the processor's system and is viewable through the user's computer, wherein the user interface comprises:
(i) a first user input feature operable to initiate scanning of photographs by a scanner coupled with the user's computer and uploading of a scanned image from the scanner to the processor's computer system,
(ii) a second user input feature operable to permit the user to make a plurality of crop selections within the scanned image, and
(iii) a third user input feature operable to cause a plurality of image files to be created in accordance with the plurality of crop selections and stored on the processor's computer system.

20. The system of claim 19, wherein the processor's computer system comprises a logic configured to create all of the plurality of image files to be created from the scanned image in response to a single actuation of the third input feature by the user.
